(19) United States
(12) Patent Application Publication
(10) Pub. No.: US 2013/0208123 A1
(43) Pub. Date: Aug. 15, 2013

(54) Method and System for Collecting Evidence in a Security System

(71) Applicants: Samir Lakhani, Bangalore (IN); Sandeep Patil Pundlik, Bangalore (IN); Aditya Shrivastava, Bangalore (IN)

(72) Inventors: Samir Lakhani, Bangalore (IN); Sandeep Patil Pundlik, Bangalore (IN); Aditya Shrivastava, Bangalore (IN)

(73) Assignee: Honeywell International Inc., Morristown, NJ (US)

(21) Appl. No.: 13/371,508

(22) Filed: Feb. 13, 2012

(51) Int. Cl. H04N 7/18

(52) U.S. Cl. 348/159; 348/143; 348/E07.085

(57) ABSTRACT

An apparatus for a security system is described. The apparatus includes a plurality of security cameras, a monitoring processor that tracks a focus of attention of a user via selection of cameras one at a time from among the plurality of security cameras, a collection processor that detects an evidence collection request from the user, opens an evidence file in response thereto and saves a sequence of video images from at least some of the plurality of video cameras into the evidence file based upon the tracked focus of attention of the user.

### FIELD

The field relates to security systems and more particularly to retrieving images from security cameras of the security system.

### BACKGROUND

Security systems are generally known. Such systems may include a physical barrier (e.g., a fence, walls, etc.) to entry to a secure area. A number of sensors may be used to detect intruders within the secure area. For example, doors and windows may be provided with perimeter switches that are activated by entry by an intruder. As an alternative to or in addition to perimeter switches, many security systems use intrusion detectors that detect motion of intruders from a distance. These types of intrusion detectors may be based upon infrared detection or processing images captured by a closed circuit television (CCTV) camera.

While perimeter switches and motion detectors are effective, they often do not detect intruders in all situations. In some cases, the sensitivity of such devices must be adjusted such that blowing debris or small animals do not trigger an alarm.

Unfortunately, by setting such devices to avoid false alarms, intruders may be missed. After a security breach in such cases, security personnel must manually review security camera recordings to detect and obtain images of intruders and their activity in order to gather evidence for prosecution. Upon detecting the intruder in the camera recordings, security personnel may use bookmarking features of the security system to identify images within the recordings for later reference.

However, the use of bookmarks is tedious. Where many cameras are involved bookmarks can be missed resulting in lost evidence. Because of the importance of such evidence, a better method is needed for tracking such evidence.

### BRIEF DESCRIPTION OF THE DRAWINGS

FIG. 1 is a block diagram of a security system shown generally in accordance with an illustrated embodiment;

FIGS. 2A-B depicts the display of images by the system of FIG. 1;

FIG. 3 depicts additional detail of FIG. 2B; and

FIG. 4 depicts the detection of a sustained direction of travel of an intruder detected by the system of FIG. 1.

### DETAILED DESCRIPTION OF AN ILLUSTRATED EMBODIMENT

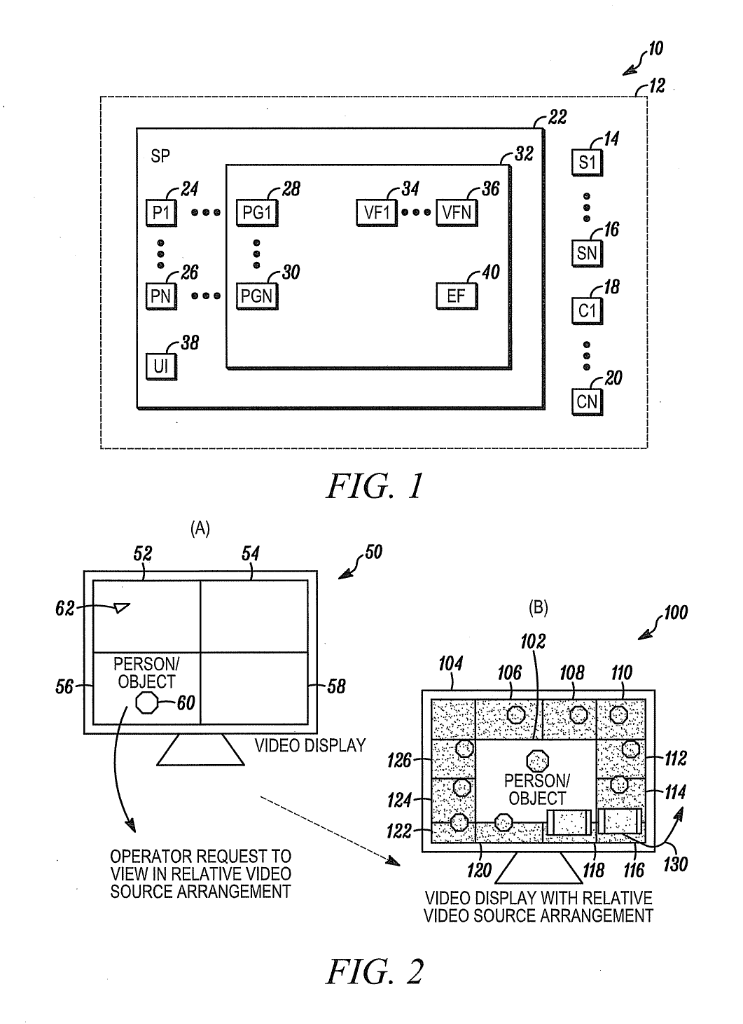

FIG. 1 is a security system 10 shown generally in accordance with an illustrated embodiment of the invention. Included within the security system 10 may be a number of intrusion sensors 14, 16 that are connected to a security panel 22 and that detect intruders within a secure area 12. The intrusion detectors 14, 16 may be perimeter switches, motion detection devices or may be based upon any other appropriate technology. The intrusion sensors 14, 16 may be connected to the security panel 22 via wires or via a wireless transceiver located within each of the sensors 14, 16 and panel 22.

Also included within the secure area 12 may be a number of cameras 18, 20. The cameras 18, 20 may also be connected to the panel 22 via wires or via a wireless transceiver located within each of the cameras 18, 20 and panel 22.

Located within the control panel 22 may be one or more programmed processors 24, 26. Processors 24, 26 may be programmed with one or more software computer programs 28, 30 loaded from a non-transitory computer readable medium (memory) 32.

Of the processors 24, 26, at least one processor 24, 26 (e.g., a motion detection processor) may process video images from each of the cameras 18, 20 to detect motion within the images from the camera 18, 20.

Another processor 24, 26 (e.g., an alarm processor) may detect intruders detected by sensors 14, 16 or by the motion detection processor 24, 26. In response, the alarm processor 24, 26 may activate an intrusion alarm and/or send an alarm message to a central monitoring station.

Other processors 24, 26 may receive a continuous sequence of video images from each of the cameras 18, 20 and continuously save those images into one or more video files 34, 36. An identification processor 24, 26 may provide a time stamp and an identifier of the camera 18, 20 that provided the sequence of images that is, in turn, saved along with each of the images.

In addition to saving the images from each of the cameras 18, 20, a user interface (e.g., a computer monitor and keyboard) 38 may be provided. The user interface 38 allows a security guard to view images from each of the cameras 18, 20 in real time as the images are collected.

FIG. 2A depicts a screen 50 that may be displayed to the security guard through the user interface 38. In this situation, the screen 50 may show a respective window 52, 54, 56, 58 with reduced resolution image of each camera 18, 20 within the security system 10. Alternatively, if too many cameras 18, 20 are present within the system 10, then the cameras may scroll across the screen 50 in a predetermined order.

In general, intruders may be detected within the images provided by the cameras 18, 20 via the motion detection processors 24, 26 or via one or more security guards seated at the user interface 38. If an intruder 60 is detected by a motion detection processor 24, 26, then the guard may be alerted via a visual indicator associated with the window 56 displaying the intruder 60. For example, the intrusion detection processor 24, 26 may cause highlighting around the window 56 to flash. If the system 10 contains too many cameras 18, 20 to be displayed at any one time and the detected intruder 60 is not currently displayed on the screen 50, then a sequencing processor 24, 26 within the panel 22 may advance the sequence to display the video from the camera 18, 20 from which the intruder 60 has been detected within one of the windows 52, 54, 56, 58.

Alternatively, the system 10 may not include motion detection capability or the guard may observe and detect the intruder 60 before the intruder 60 is detected by the motion detection processors 24, 26. In this case, the guard may place a cursor 62 over the focus of attention of the guard (i.e., the window 56 showing the intruder 60) and activate (e.g., double clicks on) a switch associated with the cursor 62 to select the particular camera 18, 20 displayed in the window 56.

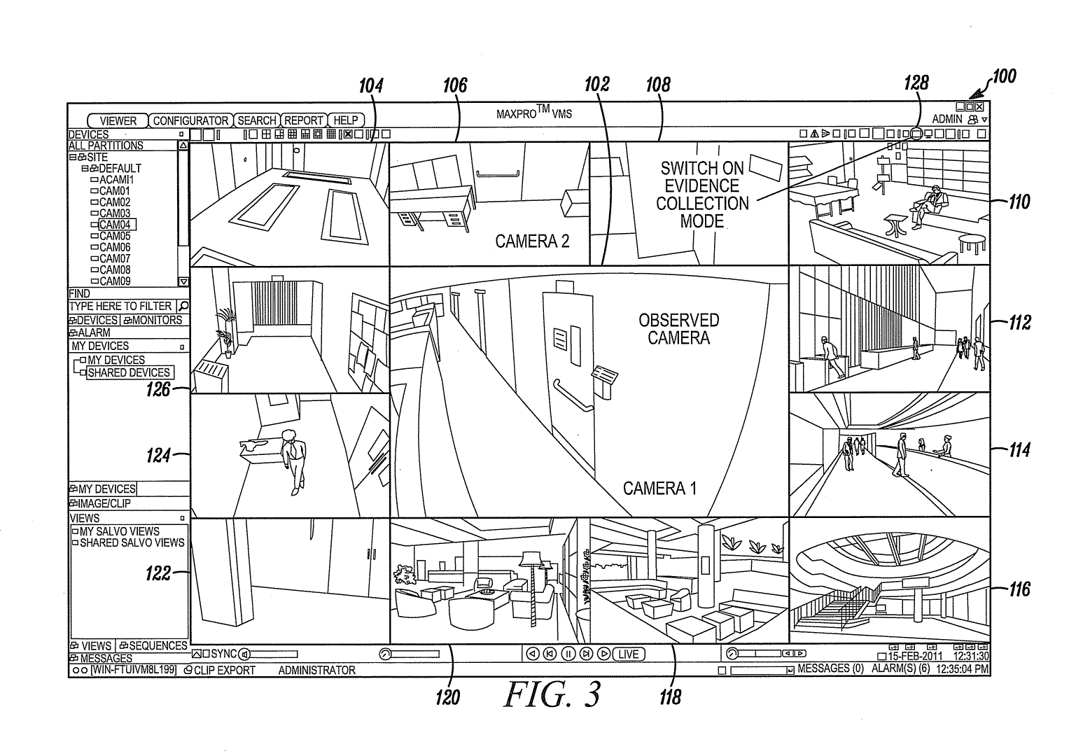

By double clicking on a window 56 depicting the intruder 60, the system 10 selects and displays the selected camera 18, 20 and surrounding cameras 18, 20 as shown in FIG. 2B. In this case, the selected camera 18, 20 occupies a center window 102 with a higher relative resolution than surrounding windows 104, 106, 108, 110, 112, 114, 116, 118, 120, 122, 124, 126. For example, FIG. 3 shows an example of an interior of a building where the center of attention provided by the enhanced window 102 is a side view of an exit to the building. Similarly, window 106 shows a front view of the exit. Other windows 104, 108, 110, 112, 114, 116, 118, 120, 122, 124, 126 show video from cameras viewing adjoining areas.

In this regard, a mapping processor 24, 26 within the alarm panel 22 may map video from each of the adjoining cameras 18, 20 onto the computer desktop or screen 100 as shown in FIG. 2B and 3. As shown in FIG. 3, the mapping processor may provide a number of windows 102, 104, 106, 108, 110, 112, 114, 116, 118, 120, 122, 124, 126 and map the video from each respective adjoining camera 18, 20 into one of the windows. As noted above, one of the windows (e.g., window 102) is a default position with a higher resolution and is the focus of attention of the guard monitoring the respective video sequences from the cameras 18, 20.

During normal operation, the mapping processor 24, 26 may monitor a position of a cursor 62 and a switch associated with the cursor 62. If the guard should wants to change his focus of attention, then the guard places the cursor 62 over one of the other windows and activates (e.g., double clicks) the switch associated with the cursor 62. Alternatively, the guard may place the cursor 62 over a selected window and drag the camera 18, 20 to the default window 102. In response, the mapping processor 24, 26 may reverse the relative positions of the camera images shown in the default or focus window 102 and the window over which the cursor 62 was located when the switch was activated. For example, in FIG. 3, images from Camera 1 are shown displayed in window 102 and images from Camera 2 are shown displayed in window 106. In this case, if the user were to place the cursor 62 over window 106 and activate the switch associated with the cursor, then (subsequent to the switch activation), the images from Camera 2 would be displayed in default window 102 and the images from Camera 1 would be displayed in window 106.

Included within the screen 100 may be an evidence collection activation button 128 for an evidence collection system. Under one illustrated embodiment, the evidence collection system may include a collection processor 24, 26 that monitors the button 128 for indication that video evidence (video frames) should be collected 130 from one or more of the cameras 18, 20. Upon activation of the button 128, the collection processor 24, 26 may open an evidence file 40 for collection of a sequence of video frames from the one or more cameras 18, 20. Alternatively, the collection processor 24, 26 may save identifiers of a camera 18, 20 and a time stamp of the frame to be collected.

The collection processor 24, 26 may also activate a monitoring processor 24, 26 that tracks a focus of attention of the guard and records video frames, one frame (and camera) at a time, into the evidence file. Under one particular embodiment, the monitoring processor 24, 26 may simply monitor for and identify the camera 18, 20 that generates the video frames that are being displayed in the default window 102.

In this case and upon receiving an identifier of the camera 18, 20 from the monitoring processor 24, 26, the collection processor 24, 26 captures video frames from the identified camera and saves the captured frames into the evidence file 40. In addition to the video frames from the identified camera 18, 20, the collection processor 24, 26 also saves a time stamp from a timing base processor 24, 26 and the identifier of the camera 18, 20 providing the video frames.

In this case, the monitoring processor 24, 26 detects each change in focus of the guard via the identity of the camera 18, 20 displaying video in the enhanced resolution window 102. As the guard changes focus by selecting a different camera 18, 20, to display video in the enhanced window 102, the collection processor 24, 26 records video from that different camera 18, 20 into the evidence file 40.

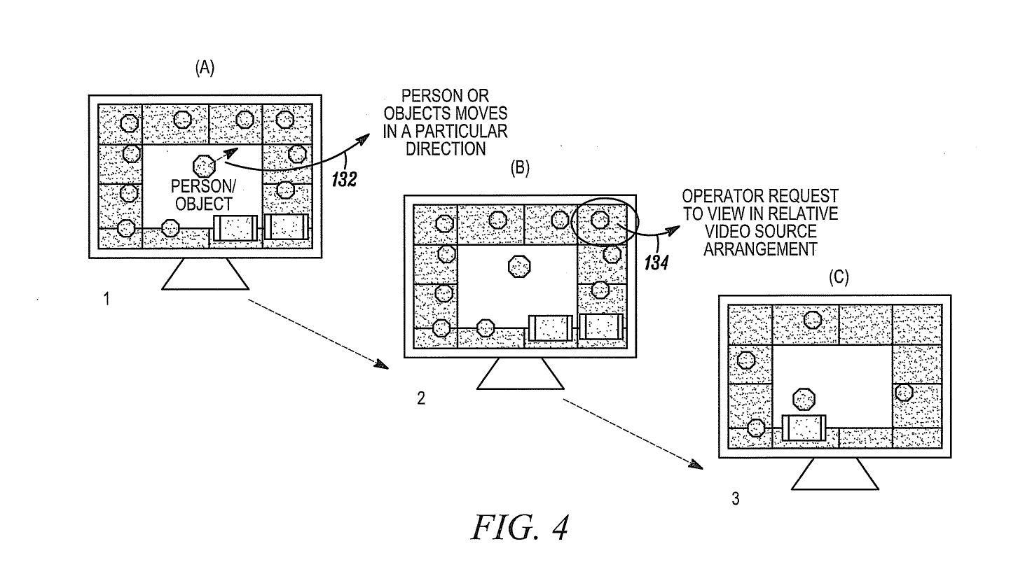

In another illustrated embodiment, a direction processor 24, 26 may automatically track movement 132 (FIG. 4A) of intruders 60 among different cameras based upon a sustained direction of travel. In this case, the selection of cameras 18, 20 may be accomplished by the direction processor 24, 26 as the intruder 60 passes out of the field of view of one camera 18, 20 and into the view 134 (FIG. 4B) of another camera 18, 20. In this case, the monitoring processor 24, 26 receives a signal indicating the focus of attention from the direction processor 24, 26 without input from the guard. As each new indication of the focus of attention is received by the monitoring processor 24, 26, the collection processor 24, 26 collects the sequence of video (FIG. 4C) from the new camera 18, 20 identified by the direction processor 24, 26.

In another illustrated embodiment, the collection processor 24, 26 may simultaneously record a sequence of video from a plurality of camera 18, 20 into the evidence file 40. In this case, the monitoring processor 24, 26 provide a first indication of the focus of attention via the identifier of the camera 18, 20 being displayed within the enhanced resolution window 102 and also a camera 18, 20 over which the cursor 62 is currently located. Under this embodiment, the guard does not have to activate the switch associated with the cursor to record video from other cameras 18, 20, but only to place the cursor over these other cameras. In this way, the guard can record relevant video from more than just the camera 18, 20 displaying the enhanced video where the guard feels that the other camera is showing important detail not shown in the enhanced window.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An apparatus comprising:
a plurality of security cameras;
a monitoring processor that tracks a focus of attention of a user via selection of cameras one at a time from among the plurality of security cameras; and
a collection processor that detects an evidence collection request from the user, opens an evidence file in response thereto and saves a sequence of video images from at least some of the plurality of video cameras into the evidence file based upon the tracked focus of attention of the user.

2. The apparatus as in claim 1 further comprising a camera selection processor that detects the user focus of attention via the user placing a cursor over a camera of the plurality of cameras on a display and activating a switch associated with the cursor and, in response, the camera selection processor moves the selected camera to a selected location with higher camera resolution.

3. The apparatus as in claim 1 further comprising a tracking processor that detects a location of suspicious objects within each of a plurality of windows where each window displays a sequence of images from a respective security camera of the plurality of cameras and where the tracking processor selects at least one of the plurality of windows at a time based upon the detected location of the suspicious object and tracks the location of the suspicious object among the plurality of windows as the suspicious object moves across respective coverage areas of the cameras.

4. The apparatus as in claim 1 further comprising a plurality of windows on a display wherein each window of the plurality of windows displays video from a respective one of the plurality of camera.

5. The apparatus as in claim 4 wherein one window of the plurality of windows has a greater resolution that the other windows of the plurality of windows and defines the focus of attention of the user.

6. The apparatus as in claim 1 further comprising an identification processor that saves a time stamp and identifier of the source camera of the plurality of cameras along with each saved video sequence.

7. An apparatus comprising:
a user interface that receives from an instruction from a user to collect video evidence;
a tracking processor that detects a location of suspicious objects within each a plurality of windows where each window displays a sequence of images from a respective security camera and where the tracking processor selects at least one of the plurality of windows at a time based upon the detected location of the suspicious object and tracks the location of the suspicious object among the plurality of windows as the suspicious object moves across respective coverage areas of the cameras; and
a collection processor that opens an evidence file in response to the instruction from the user and that saves video from the selected windows into the evidence file based upon the tracked location of the suspicious object.

8. The apparatus as in claim 7 further comprising the tracking processor selecting one of the plurality of windows at a time and saves the sequence of images from the selected window into the evidence file.

9. The apparatus as in claim 7 further comprising a cursor controlled by the user that provides the detected location of the suspicious object to the tracking processor via a switch associated with the cursor.

10. The apparatus as in claim 7 further comprising a motion follower processor that detects motion within each of the plurality of windows and provides the detected location of the suspicious object to the tracking processor.

11. The apparatus as in claim 7 further comprising a motion follower processor that detects motion within each of the plurality of windows and provides the detected location of the suspicious object among the plurality of windows to the tracking processor by matching indications of motion of the suspicious object among adjacent cameras.

12. The apparatus as in claim 11 wherein the indication of motion further comprises a sustained direction of motion.

13. An apparatus comprising:
a user interface that receives from the user an instruction to collect video evidence;
a tracking processor that tracks a position of a cursor on a display screen over a plurality of windows where each window displays a sequence of images from a respective security camera; and
a collection processor that opens an evidence file in response to the instruction from the user and that saves video from a selected one of the plurality of windows at a time into the evidence file based upon the position of the cursor and a window selection instruction from the user.

14. The apparatus as in claim 13 further comprising a default window of the plurality of windows from which the collection processor initially collects and saves video.

15. The apparatus as in claim 14 wherein the default window has a larger relative size than the other windows of the plurality of windows for better resolution of a subject matter of the evidence collection.

16. The apparatus as in claim 14 further comprising a mapping processor that swaps locations of the plurality of windows on the display screen between a location of the default window and a respective predetermined location of each of the plurality of windows based upon the identity of the selected one of the plurality of windows.

17. The apparatus as in claim 13 further comprising a tracking processor that saves an identity of the respective camera of the selected one of the plurality of windows and a time of collection of the sequence of video images into the evidence file.

18. The apparatus as in claim 13 wherein the saved video further comprises real time video.
